(19) United States
(12) Patent Application Publication
(10) Pub. No.: US 2002/0097226 A1
(43) Pub. Date: Jul. 25, 2002

(54) Folding keyboard

(76) Inventor: Mei-Ling Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/764,395

(22) Filed: Jan. 19, 2001

(51) Int. Cl. G09G 5/00

(52) U.S. Cl. 345/168

(57) ABSTRACT

A folding keyboard includes preferably three pivotally connected seats and the same number of keypads separately attached to a top of the seats through engagement of the keypads with slide slots provided on the seats. A middle seat is provided at two ends of two lateral edges with knuckles, in which oil-pressure elements are mounted. Two side seats are respectively provided at two ends of an inner edge with two lugs that are pivotally connected to the knuckles and able to turn through operation of the oil-pressure elements. The side seats may be pivotally turned toward the middle seat so as to overlap with one another to form a compact body and be held in this state by engaging catches with retaining holes provided on the folding keyboard at predetermined positions. And, disengagement of the catches from the retaining holes enables the oil-pressure elements to slowly turn open the side seats to expose the keypads for use.

### BACKGROUND OF THE INVENTION

The present invention relates to a folding keyboard that can be easily folded into a compact body for convenient carry and storage and turned open to an extended position for use.

A keyboard for general computers usually requires a large length to hold a large number of keys thereon. Such long keyboard is not convenient for carry or storage and not suitable for portable computers, palm computers, personal digital assistants (PDAs), Wireless Application Protocol (WAP) mobile phones, and many other IA products that have small size and are now very popular in the markets. Therefore, it is an important target of the computer industry to develop a keyboard that can have a reduced volume when it is not in use to facilitate convenient carry and storage.

### SUMMARY OF THE INVENTION

A primary object of the present invention is to provide a folding keyboard that can be folded into a compact body when it is not in use. To achieve the above and other objects, there is provided a folding keyboard including preferably three pivotally connected seats and the same number of keypads separately attached to a top of the seats through engagement of the keypads with slide slots provided on the seats. A middle seat is provided at two ends of two lateral edges with knuckles, in which oil-pressure elements are mounted. Two side seats are respectively provided at two ends of an inner edge with two lugs that are pivotally connected to the knuckles and able to turn through operation of the oil-pressure elements. After the keypads on the two side seats are slightly pulled outward along the slide slots, the side seats may be pivotally turned toward the middle seat so as to overlap with one another to form a compact body and be held in this state by engaging catches with retaining holes provided on the folding keyboard at predetermined positions. And, disengagement of the catches from the retaining holes enables the oil-pressure elements to slowly turn open the side seats to expose the keypads for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective of a folding keyboard according to a preferred embodiment of the present invention;

FIG. 2 schematically shows knuckles adopted in the present invention;

FIG. 3 is a rear elevation of the folding keyboard of the present invention in a fully extended position;

FIGS. 4 and 5 show the manner of folding the folding keyboard of the present invention into a compact body; and

FIG. 6 is a perspective of the folding keyboard in an extended position with, for example, a PDA connected thereto.

### DETAILED DESCRIPTION OF THE PREFERRED EMBODIMENTS

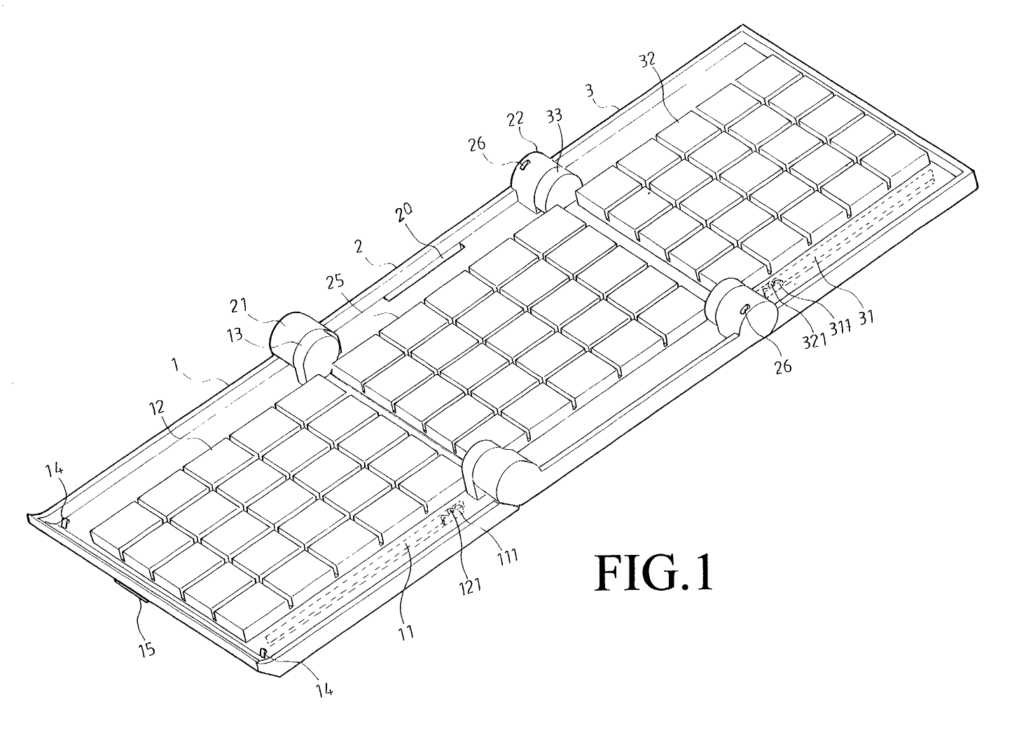

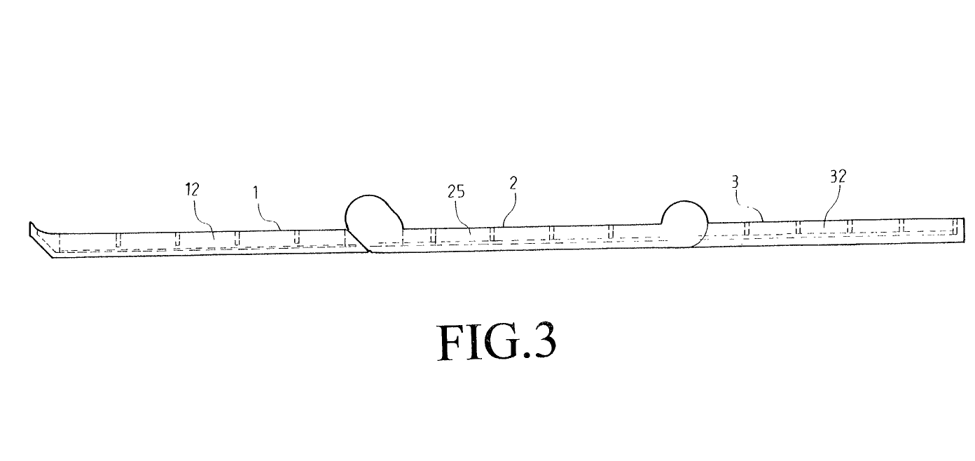

Please refer to FIGS. 1, 2 and 3 at the same time. The present invention relates to a folding keyboard that mainly includes a seat portion formed from pivotally connected left seat 1, middle seat 2, and right seat 3, and a key portion formed from a left keypad 12, a middle keypad 25, and a right keypad 32. The keypads 12, 25, and 32 are attached to a top of the left, the middle, and the right seats 1, 2, 3, respectively, by engaging their respective lower part with two slide slots provided on each of the seats at predetermined positions.

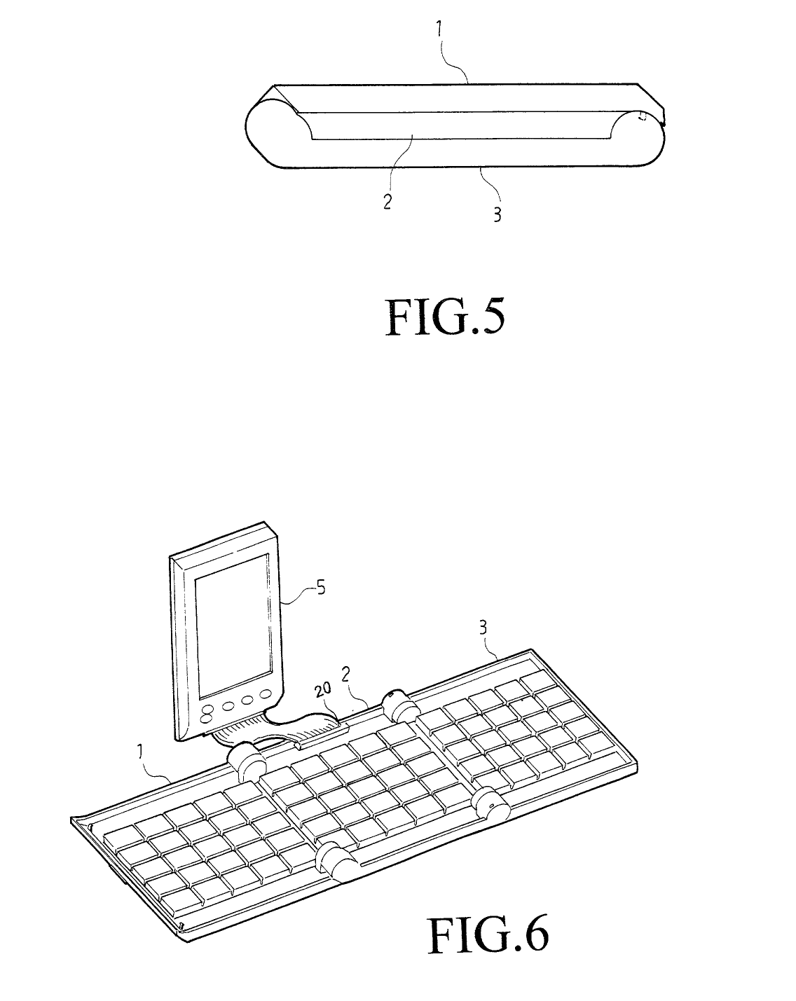

The middle seat 2 is provided at a front longitudinal edge with a socket 20 into which a separate electronic product, such as a computer, a mobile phone or a personal digital assistant (PDA) 5 is inserted and electrically connected (see FIG. 6). The middle seat 2 is also provided at outer ends of two lateral edges with two left and two right knuckles 21, 22 in which oil-pressure elements 23, 24 are mounted.

The left and the right seats 1 and 3 are provided at predetermined positions with the slide slots 11 and 31, respectively. Stopper 111 and 311 are separately provided in the slide slot 11 and 31 at an end of the slide slots 11, 31 separately close to the two lateral edges of the middle seat 2. The left and the right keypads 12, 32 are provided with projections 121 and 321 at their lower part corresponding to the stoppers 111 and 311, respectively, such that the projections 121, 321 normally engage with the stoppers 111 and 311, respectively, to hold the left and the right seats 1, 3 and accordingly, the left and the right keypads 12, 32, to closely locate at two sides of the middle seat 2.

The left seat 1 and the right seat 3 are provided at their respective inner edge with two lugs 13 and 33, respectively. The lugs 13, 33 are located between the two left and the two right knuckles 21 and 22, respectively, such that the oil-pressure elements 23, 24 in the knuckles 21, 22 are extended into and pivotally connected to the lugs 13, 33. Two catches 14 are symmetrically provided on the top of the left seat 1 near two ends of an outer edge thereof and are connected to a switch 15 provided at a bottom of the left seat 1 at the same edge having the catches 14 provided thereat. Two retaining holes 26 are separately correspondingly provided on the two right knuckles 22 of the middle seat 2 for receiving the catches 14.

Keys on the left, the middle, and the right keypads 12, 25 and 32 may be made of thin film or electrically conductive rubber. After the left, the middle, and the right seats 1, 2 and 3 with the left, the middle, and the right keypads 12, 25 and 32 attached thereto are pivotally turned to a fully extended position, a complete keyboard for general notebook computers, palm computers, and WAP mobile phone is provided.

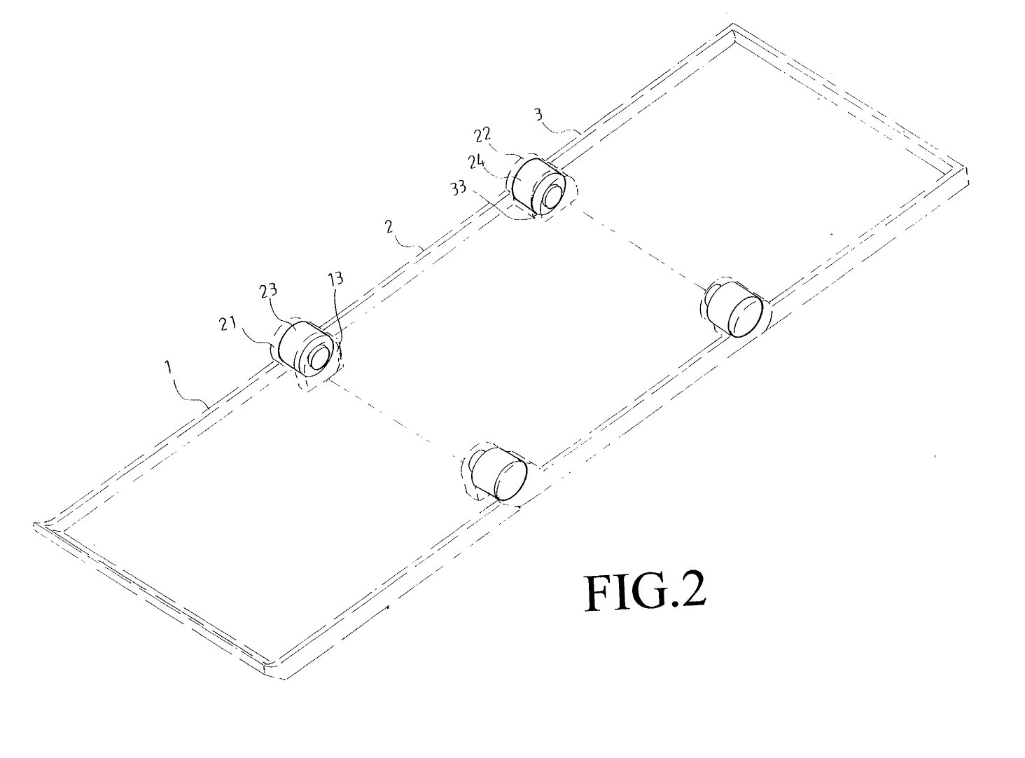

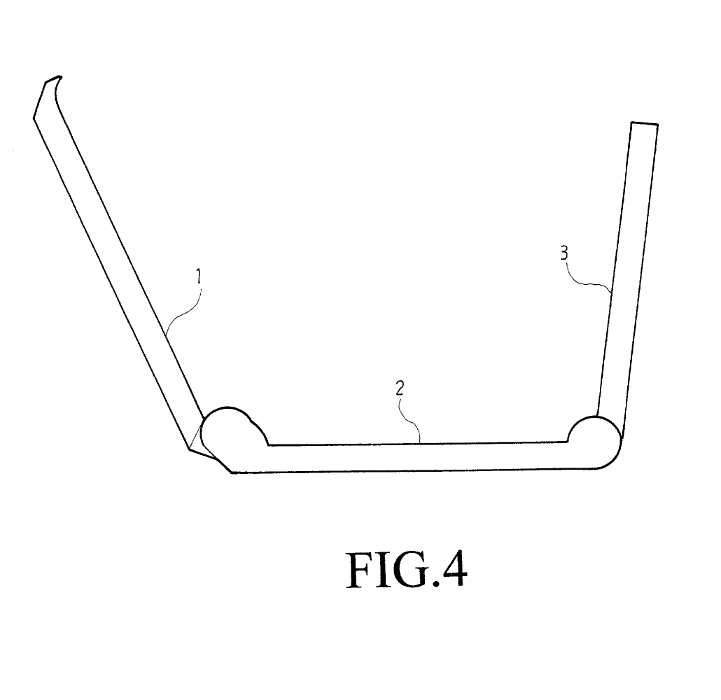

Please refer to FIGS. 2, 3, 4 and 5 at the same time. When the folding keyboard is not in use, a user may first pull the left and the right keypads 12, 32 outward so that the projections 121, 321 disengage from the stoppers 111, 311 and are guided by the slide slots 11, 31 for the left and the right keypads 12, 32 to move away from the middle keyboard 25 by a predetermined small distance. Then, the right seat 3 is pivotally turned about the lugs 33 relative to the right knuckles 22 to locate over the middle seat 2, and the left seat 1 is successively pivotally turned about the lugs 13 relative to the left knuckles 21 to locate over the right seat 3. At this point, the catches 14 engage into the retaining holes 26 on the right knuckles 22 to securely hold the folded seats 1, 2 and 3 in a compact body that facilitates convenient carry and storage.

To use the folding keyboard, simply pull the switch 15 to disengage the catches 14 from the retaining holes 26, and the oil-pressure elements 23, 24 in the left and the right knuckles 21, 22 automatically rotate to slowly turn the left seat 1 and the right seat 3 outward to their extended position and expose the left, the middle, and the right keypads 12, 25 and 32 for use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A folding keyboard, comprising a seat portion and a key portion, said seat portion including a plurality of and preferably three seats, and said key portion including keypads in the same number as that of said seats; said seats being provided at predetermined positions with slide slots into which said keypads are engaged to attach to a top of said seats; a middle seat of said seats being provided at two ends of two lateral edges with two left and two right knuckles, in which oil-pressure elements are mounted, and two side seats of said seats being respectively provided at two ends of an inner edge adjacent to said middle seat with two lugs, such that said lugs are located between and pivotally connected to said left and said right knuckles and turnable by said oil-pressure elements in said knuckles; whereby said folding keyboard may be folded into a compact body for easy carry and storage by sequentially pivotally turning said side seats about said lugs relative to said knuckles toward said middle seat to overlap with one another, and said side seats may be automatically slowly and pivotally turned to extended positions through operation of said oil-pressure elements and to expose said keypads and provide a complete keyboard for use.

2. A folding keyboard as claimed in claim 1, wherein said middle seat is provided at two of said knuckles at the same one edge with two retaining holes, and one of said two side seats opposite to said knuckles having said retaining holes are correspondingly provided with catches for engaging into said retaining holes, such that said folding keyboard in a completely folded state is securely kept in the form of said compact body by engagement of said catches with said retaining holes.

3. A folding keyboard as claimed in claim 2, wherein said catches are connected to a switch provided on said side seat having said catches provided thereat, and a pull of said switch is able to disengage said catches from said retaining holes, allowing said oil-pressure elements to slowly turn open said side seats.
